(19) United States
(12) Patent Application Publication
(10) Pub. No.: US 2015/0006122 A1
(43) Pub. Date: Jan. 1, 2015

(54) Method and Apparatus for Real-time Inter-organizational Probabilistic Simulation

(71) Applicant: Jing Du, San Antonio, TX (US)

(72) Inventor: Jing Du, San Antonio, TX (US)

(21) Appl. No.: 13/929,903

(22) Filed: Jun. 28, 2013

(51) Int. Cl. G06F 17/50

(52) U.S. Cl. CPC G06F 17/5009
USPC 703/2

(57) ABSTRACT

A method enables multiuser and distributed “what you see is what you get” probabilistic simulation. A method projects a problem P into k sub-problem spaces with at least 1 dimension, and executes the sub-simulations for each sub-problem in parallel with user's model initialization and parameterization process. A method utilizes “Simulate As You Operate” (SAYO) and “Batch Generation Batch Computation” (BGBC) techniques to perform data retrieval, random number generation and simulation in parallel with the user's model initialization and parameterization process. An apparatus only repeats the simulation process on the affected part of the model and holds the model inputs/outputs of unaffected part of the model fixed. A communication protocol allows users at different sites or different organizations to perform real-time simulations on the same model. An apparatus enables a process of sharing and benchmarking the model-associated statistics by aggregating and publishing the submitted information by users.

### TECHNICAL FIELD

The disclosure relates generally to uncertainty analysis. In particular it is pertaining to the efficiency improvement of probabilistic simulation.

### BACKGROUND

Many of the features, events and processes which control the behavior of currently available complex systems will not be known or understood with certainty. This is because, for most real-world systems, at least some of the controlling parameters, processes and events are often stochastic, uncertain and/or poorly understood. The objective of many decision support systems is to identify and quantify the risks associated with a particular option, plan or design. Incorporating uncertainties into the analysis of system behavior is called uncertainty analysis. Uncertainty analysis is part of every decision we make. We are constantly faced with uncertainty, ambiguity, and variability. And even though we have unprecedented access to information, we can't accurately predict the future. Simulation, in this case, is a possible solution which lets us visualize all the possible outcomes of the decisions and assess the impact of risk, allowing for better decision making under uncertainty. Simulating a system in the face of such uncertainty and quantifying such risks requires that the uncertainties be quantitatively included in the calculations.

Many simulation tools and approaches are essentially deterministic, although seemingly probabilistic. In a deterministic simulation, the input variables for a model are represented using single values (which typically are described either as “the best guess” or “three-case scenarios” including best case, worst case and the most likely case). Unfortunately, this kind of simulation, though capable of providing some insight into the underlying mechanisms, is not well-suited to making predictions to support decision-making, as it cannot quantify the inherent risks and uncertainties. A simple example is preparation of budget for a project. Under a reductionist consideration, a project can be divided into a set of sub-units according to the WBS (work breakdown structure) or by business functions. Each unit may be budgeted by applying “the most likely” estimate, and the project budget is simply the summation of all “the most likely” estimates from each individual unit. When the probabilistic distributions are asymmetric, this practice always yields biased project budget due to “Central Limit Theorem”. Unfortunately, this practice becomes a standard in many areas.

Probabilistic simulation (also known as the probabilistic modeling method), on the other hand, can better capture the uncertainties coherently, with a full reflection of the probabilistic rules. Probabilistic simulation models a real world system to one or more generative models with everything stochastically connected, and simulates the possible outcomes of the system in an aggregated way. It provides a powerful framework for analyzing and visualizing complex systems with the vast amount of data that have become available in science, scholarship and everyday life. This technique is used by professionals in such widely disparate fields as finance, project management, energy, manufacturing, engineering, research and development, insurance, oil and gas, transportation, and the environment.

It is possible to quantitatively represent uncertainties in probabilistic simulations. The uncertainties are explicitly represented by specifying inputs as probability distributions in the process of probabilistic simulations. If the inputs describing a system are uncertain, the prediction of future performance is necessarily uncertain. That is, the result of any analysis based on inputs represented by probability distributions is itself a probability distribution. Hence, whereas the result of a deterministic simulation of an uncertain system is a qualified statement (“if we build the dam, the salmon population could go extinct”), the result of a probabilistic simulation of such a system is a quantified probability (“if we build the dam, there is a 20% chance that the salmon population will go extinct”). Such a result on this case, quantifying the risk of extinction) is typically much more useful to decision-makers who might utilize the simulation results.

In order to compute the probability distribution of predicted performance, it is necessary to propagate (translate) the input uncertainties into uncertainties in the outputs. A variety of methods exist for propagating uncertainty. One common technique for propagating the uncertainty present in the various aspects of a system to the predicted performance is Monte Carlo simulation. In Monte Carlo simulation, the simulation for the entire system is repeated a large number (e.g., 1,000) of times. Each simulation is equally likely, and is referred to as a realization of the system. For each realization, all of the uncertain variables are sampled (i.e., a single random value is selected from the specified distribution describing each variable). The system is then simulated through time (given the particular set of input variables) such that the performance of the system can be computed. This results in a large number of separate and independent results, each representing a possible “future” state for the system (i.e., one possible path the system may follow through time). The results of the independent system realizations are assembled into probability distributions of possible outcomes.

The process described above seems simple, but is inefficient in most cases. Roughly speaking, a probabilistic simulation has two major processes: modeling and simulation. Modeling process aims to reproduce the real world problems. Users need to define and parameterize a collection of random variables and the operations over them, including arithmetical operations, logic operations, matrix operations and etc. While simulation, based upon the modeling, executes the operations and yields the results. The traditional probabilistic simulation method is inefficient in a sense that it separates the modeling process and the simulation process. For a traditional probabilistic simulation, such like a Monte Carlo simulation, the analysts first models the problem and initializes a set of random number generators. Simulation won't start until the modeling process is completed. Then, random number generators realize a random number for each of the model variable, which will be executed by the model, and yield just one result. This is called a trial. The second trial occurs when the first one is completely over. In this sense, simulation is completely isolated from modeling.

This creates some realistic issues. For simple models, it works. But for increasingly common complex models with thousands of, sometimes hundreds of thousands of variables and even more operations, facing contemporary complex problems, traditional method becomes unbearably inefficient. Real-time simulation is almost impossible which makes decision making very slow. Furthermore, for “what if scenario” analysis, when only part of the model needs to be changed, the above described process (random number generation and operation execution) have to be repeated which is obviously an overhead. In sum, the following limitations of traditional probabilistic simulation method have been recognized:
The modeling and simulation processes are isolated;
The efficiency of simulation mainly depends on the capacity of decide being used by the user. It is difficult to control the quality;
Even if only part of the model has been changed, the entire model, including unaffected parts, should be calculated again, which is a waste of time and system resource;
It is difficult to exchange risk models or risk information across organizations; or to ensure the authenticity of the risk models or risk information received from another source;
The modeling and interpretation of risk information requires professionals such as statistician, who may not be available in every organization;
The complexity of set-up and modeling process of simulation makes it a “professional” task; idiot-proof applications on portable devices are therefore impossible;
There is a lack of integration between the simulation and post-simulation in-depth analysis;
Current probabilistic simulation method is not scalable and thus not usable for big data analysis; and
Risk modeling is isolated and unique for each organization. There is no proven method to benchmark its “risk level” against other industry peers under the present risk modeling framework.

This disclosure presents a method and an apparatus that realizes real-time probabilistic simulation for large and complex models by two technologies namely “Simulate as You Operate” (SAYO) and “Batch Generation Batch Computation” (BGBC). The proposed method and apparatus are expected to change the user experience of probabilistic simulation thoroughly.

### SUMMARY

This disclosure summarizes a method and an information management, analysis and storage apparatus called RISK™ (Real-time Inter-locational Simulation Kit) that utilizes process improvement and cloud based distributed computing to enable real-time probabilistic simulation inter-organizationally and inter-locationally. It enables “what you see is what you get” (WYSIWYG) simulation for geographically dispersed remote teams.

In one embodiment, RISK™ projects the problem P into k sub-problem spaces, and each sub-problem pᵢ is embedded in a mᵢ dimensional space. When the mᵢ variables of sub-problem pᵢ have been parameterized completely, a probabilistic simulation may be executed immediately on a cloud based computing unit, as the user may be still parameterizing other sub-models. The simulation outputs will be aggregated when all the sub-models have been defined and simulated, and will be sent back to the web-based user interface. The above processes are executed instantaneously and in parallel as the user is still doing the model initialization and parameterization without any interruptions.

In another embodiment, RISK™ performs data retrieval and/or Random Number Generations (RNGs) for the uncertainty and/or risk model in parallel with the user initiated model parameterization process. After it receives the distribution parameters (parameterization) of at least one model input, RISK™ first checks if there are any existing random number tuples (RNTs) in a database called DigitBank™ that are stored from previous modeling and simulation which follow the defined distribution. If there is an existing tuple that follows the defined distribution, Model Evaluation module will move the RNTs to the temporary storage or cache for future computation. If there is no existing RNTs that follows the defined distribution, Model Evaluation module utilizes the source random numbers, called DigitSource™, to generate random numbers following the defined distributions and save them as RNTs in the temporary storage or cache for future computation. The above processes are executed instantaneously and in parallel as the user is still doing the model initialization and parameterization without any interruptions.

In another embodiment, a system creates an index by saving a piece of address information that maps the user request into a particular address of DigitSource™ and/or DigitBank™ for RNGs and/or RNTs retrievals, and binds it to the specific user or model, in the DigitBank™ to make the information reusable with efficiency and speed. True random numbers saved in the DigitSource™ may be updated regularly but the mapping addresses of a particular user or particular model won't be changed to maintain consistency. The above processes are executed instantaneously and in parallel as the user is doing the model initialization and parameterization without any interruptions.

In another embodiment, a system holds the model inputs and outputs, such as the random number tuples used in the simulation and simulation results of unaffected part of the model fixed, and repeats the process described on the affected part of the model only, if and when only a part of the model is updated. The final results will be synthesized to reflect the update to the model.

In another embodiment, a model platform allows users at different sites or different organizations to perform WYSIWYG simulations on RISK™ across locations and organizations. Any user may initiate a collaborative simulation project with remotely located other users. Any changes initiated by different users to the model will be sent to RISK™ instantaneously through computer networks such as, for example, the internet. RISK™ will perform the RNGs, RNT retrieval, model evaluation and searching and cloud based computation of the model or sub-models instantly as per the process described above. The updates of model states, if any, will be synthesized by RISK™, and sent to the web-based user interfaces instantaneously. As a result, all users are able to see the changes they made as well as the updated model states immediately after they made the changes. Meanwhile, access control and authorization operations like granting or revoking modifying and viewing rights, overriding results, moving/deleting models, creating databases for models, are performed by the system admin as per predetermined security policies.

In another embodiment, a system enables a process of sharing and benchmarking the model-associated statistics. Once a simulation project is done on RISK™, the user may select to publish the results including generic background information, model inputs, model information and model simulation outputs by submitting relevant information. The system aggregates the submitted information and calculates statistics of interest including but not limited to: model input (e.g., probability density functions (PDFs) of model variables), the mean, standard deviation, percentile, maximum and minimum values of model inputs and outputs, number of input and/or output variables, simulation time, domain or industry (such as financial, retailing, construction, and academia etc), geographic information (such as the location of the business). For very specific simulation projects, such as project schedule PERT (Project Evaluation and Review Technique) simulation, the calculated statistics may include those that of particular interests of that domain such as project duration, duration uncertainty and etc. This feature enables any user to benchmark his/her results against all the submitted results. A typical example may be the percentile of the project risk level in a project schedule PERT simulation, shown as the simulated duration uncertainty of the project; or the percentile of the expected return in a stock investment portfolio simulation; or simply the rank of counts of the simulated stocks. A set of filters may be set so the user can focus only on the interested areas or aspects.

In another embodiment, a statistical analysis module and process built in the system enable backend in-depth statistical analysis. The user may submit specific statistical analysis requests such as regression analysis and time series analysis with probability to the system, the system utilizes the submitted model information such as model inputs and simulation outputs to perform backend statistical analysis and returns the results to the user instantaneously. If other in-depth statistical analysis requests are beyond the capacity of the model, requests will be sent to experienced statistician to perform back-stage analysis and return the results to the system which will later return the results to the user. The analysis service is provided by the system. Partitioning is enabled so that sensitive and specific information pertaining to the model is hidden from any human involved process.

In another embodiment, the user interface is realized not only on personal computers, but also on portable devices such as smart phones, tablets, watches, Google glasses and etc. The model parameterizing process can be realized by multiple input methods such as touch screen, scanning, voice input and etc. Simulation process is performed on cloud based servers and results are returned to the user interfaces as numbers, graphs, colors, and sounds etc.

### DESCRIPTION OF DRAWINGS

For a better understanding of the present invention, reference is made to the detailed description of the invention, by way of example, which is to be read in conjunction with the following drawings, wherein like elements are given like reference numerals, in which:

FIG. 1 is a specification of categorization of the simulation problems according to this invention

FIG. 2 is the description of four components of simulation time according to this invention

FIG. 3 is the simulation process for different types of problems according to the proposed method and traditional method

FIG. 4 is the architecture of a proposed apparatus to realize the proposed method

FIG. 5 is a flow chart showing a typical RISK™ “What You See Is What You Get” simulation process

FIG. 6 is description of the proposed simulation method

FIG. 7 is a description of changing part of the model

FIG. 8 is a visualization of Inter-organizational and Inter-locational Simulation

FIG. 9 is an illustration of Cloud Benchmarking

FIG. 10 is an illustration of a Scheduling Example (Divisible Problem)

FIG. 11 is an illustration of how a scheduling with milestone is simulated

FIG. 12 is an illustration of Inter-locational simulation

FIG. 13 is an illustration of an example of simulating a schedule without milestones

FIG. 14 is a description of Random number tuples of VaR calculation

FIG. 15 is an illustration of Real-time VaR calculation on portable device

### DETAILED DESCRIPTION

All the technical and scientific terms referred in this disclosure carry the same connotation as most commonly comprehended by any person of ordinary skill in the field of this disclosure. In the case of any conflicting specification, the description as provided in this disclosure shall prevail. RISK™ is a method and an information management, analysis and storage apparatus that utilizes process improvement and cloud computing to enable real-time probabilistic simulation inter-organizationally and inter-locationally. It enables “what you see is what you get” simulation for remote teams, i.e., teams not located at the same place.

A model is a reproduction of a real world problem P. Under RISK™, a model can be defined as a collection of M random variables (M>=2), and the operations over them, denoted as F, including arithmetical operations, logic operations, matrix operations and so on. The result of the model simulation is denoted as R. Therefore:

R=F(P) (1)

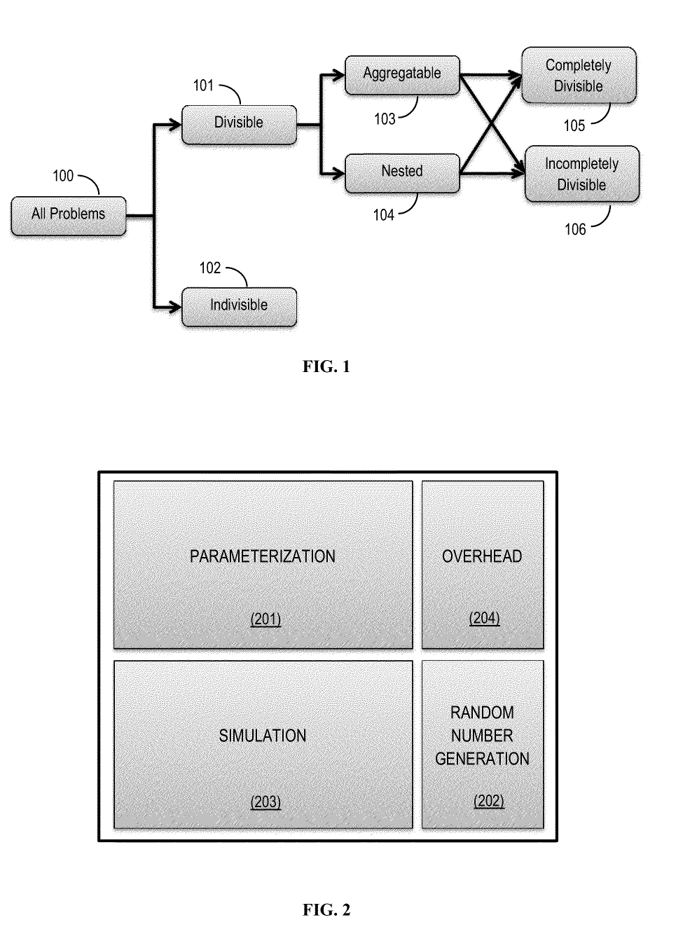

Referring to FIG. 1, according to the specific F, i.e., how a problem 100 is modeled, RISK™ categorizes a problem as divisible 101 or indivisible 102; divisible problems 101 can be further categorized into completely divisible 105 and incompletely divisible 106.

Referring to FIG. 1, divisible 101 means the original problem is either aggregatable 103 or nested 104. Aggregatable means the original problem space can be projected onto at least two sub-spaces which are independent of each other. From the perspective of practical application, aggregatable problems have at least two independent parts (sub-problems) such that each part can be simulated independently and in parallel, and the results can be synthesized later. Suppose a problem P has M variables:

P={x₁,x₂, . . . ,x_{M}} (2)

In other words, P belongs to an M-dimensional space:

Pε [symbol] ^{M} (3)

P is divisible if it can be projected into k sub-problems, and each sub-problem is embedded in a mᵢ dimensional space; i.e.,

$$\begin{matrix}P = \{ {p}_{1} , {p}_{2} , … {p}_{k} \} , \\ for any i and \\ j \leq k , {p}_{i} ∉ {p}_{j} \\ and \\ {p}_{j} ∉ {p}_{i} & ( 4 ) \\ {p}_{i} ∈ {ℛ}^{mi} & ( 5 ) \\ M = {\sum }_{i = 1}^{k} mi & ( 6 )\end{matrix}$$

The above situation is called incompletely divisible. When the mₗ variables of sub-problem 1 have been parameterized, a probabilistic simulation may be executed immediately. Denote fᵢ as the conversion function that yields the simulation result rᵢ of sub-problem pᵢ, then the above process can be described as:

r₁=f₁(p₁) at sim₁ (7)

Observe that sim1 occurs when the user is still parameterizing p₂. The parameterization process is executed in parallel with the RNG processes and simulation processes. This process will continue until the entire problem or divisible part of the problem is simulated. Then the simulation result R of the complete problem P can be written as:

R={r₁,r₂, . . . rₖ}, where

r₁=f₁(p₁) at sim₁

r₂=f₂(p₂) at sim₂

. . .

rₖ=fₖ(pₖ) at simₖ (8)

instead of

$$R = F ( P ) at {sim}_{all} , {sim}_{all} = {\sum }_{i = 1}^{k} {sin}_{i} \qquad ( 9 )$$

An extreme case of the divisible problem would be projecting the original problem P onto K sub-spaces, where each sub-space only has 1 dimension, or:

pᵢε [symbol] ¹ (10)

Therefore:

$$K = M = {\sum }_{i = 1}^{k} mi \qquad ( 11 )$$

This situation is called completely divisible. In this situation, each variable of the problem will be ready for simulation after the user parameterized and defined part of the model. The basic unit of simulation occurs between two variables.

In another situation, the problem has a nested structure 104, referring to FIG. 1. Suppose the problem P can be projected into a set of sub-spaces:

P={P_{α},P_{β},P_{γ}, . . . ,P_{δ}} (12)

For p+q+l+ . . . +n=M,p>=0,q>=0,l>=0, . . . ,n>=0:

P_{α}={x_{α1},x_{α2}, . . . ,x_{αp}}

P_{β}={x_{β1},x_{β2}, . . . ,x_{βq}}

P_{γ}={x_{γ1},x_{γ2}, . . . ,x_{γl}}

. . .

P_{δ}={x_{δ1},x_{δ2}, . . . ,x_{δn}} (13)

For each x_{αi}εP_{α},

x_{αi}={x_{β1},x_{β2}, . . . ,x_{βk}},k≦q (14)

And for each x_{βj}εP_{β},

x_{βj}={x_{γ1},x_{γ2}, . . . ,x_{γg}},g≦l (15)

Until P_{δ} has been defined. In the nesting case, P_{δ} will first be defined and parameterized, and then the lower level relative of P_{δ} will be simulated based on the outcomes of P_{δ}. This process will be repeated in parallel with the model definition and parameterization process without any interruptions until the bottom level P_{α} has been defined, parameterized and simulated. The real-time simulation for nesting problems is realized.

A problem is indivisible when the original problem space cannot be projected onto any sub-spaces.

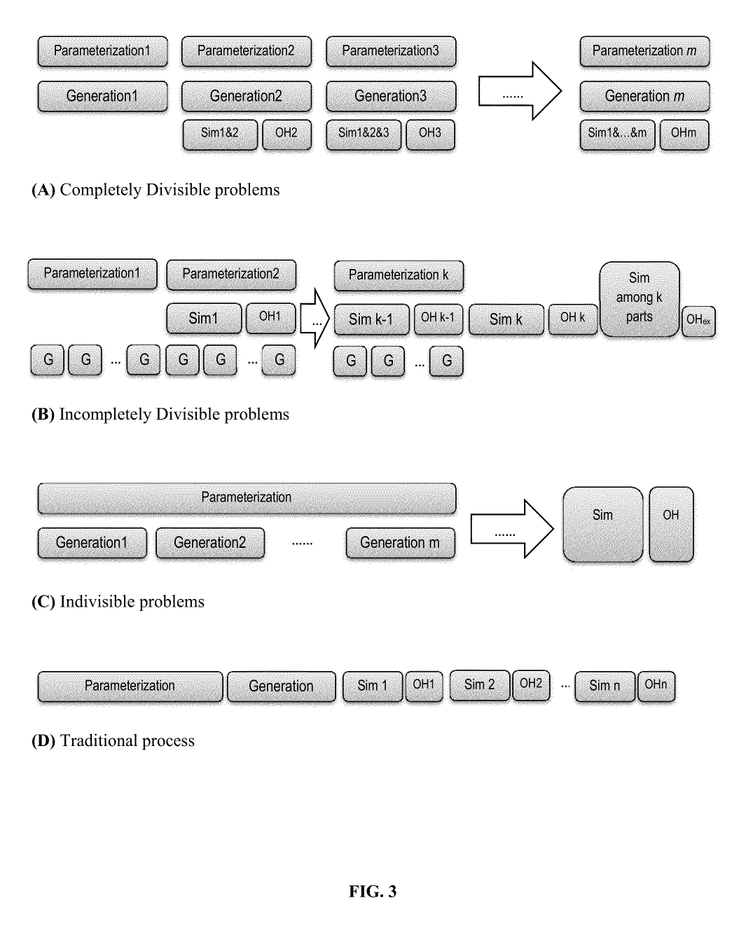

Referring to FIG. 2, the total probabilistic simulation time is divided into four components:
Parameterization time (PT or ptᵢ) 201: The time spent by the user to parameterize the model. For example, the user defines the probability density functions (PDFs) of the model inputs;
Random number generation time (GT or gtᵢ) 202: The time spent by the system to generate or retrieve random numbers for the simulation according to the arbitrary distributions defined by the user;
Simulation time (ST or stᵢ) 203: The pure time spent by the system to perform the actual simulation tasks; and
Overhead (OH or otᵢ) 204: Simulation involves lots of data fetching and processing operations and transferring. The data needs to be read and saved in the computer memory hierarchy frequently. Typically, a lot of time is required to transfer data between central processing unit (CPU) and the main memory, between CPU and secondary storage (hard disk), off-line storage and tertiary storage (e.g. tape drives), and among different hierarchical levels of the memory system. From the database operation standpoint, time is also required to perform database operations such as database initialization, read/write, insert, update, delete, merge and indexing etc. The time consumed in such operations does not directly contribute to the probabilistic simulation, and thus can be called overhead.

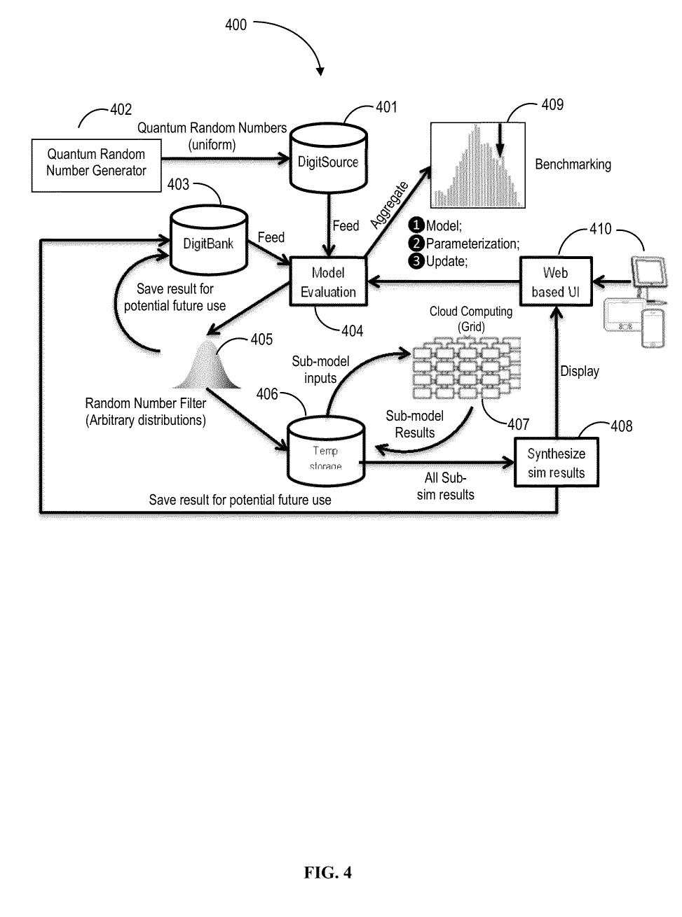

Referring to FIG. 2, the four components of a probabilistic simulation can be executed in parallel to improve the efficiency. However, the extent to which the four components can be concurrently executed varies for different types of problem, as of FIG. 1. Referring to FIG. 3 (A), for completely divisible problems the parameterization, generation, sub-simulation (and its corresponding overhead) can be executed concurrently. For each sub-simulation then, the time depends on the maximum of the above three. Assuming the parameterization takes the longest time then total time required for the simulation of a completely divisible problem is:

$${TT}_{cd} = {\sum }_{i = 1}^{m} max \{ {pt}_{i} , {gt}_{i} , ( {st}_{i + 1} + {ot}_{i + 1} ) \} = {\sum }_{i = 1}^{m} {pt}_{i} = PT \qquad ( 16 )$$

where m equals to the number of model variables and PT denotes the total time for parameterization.

Referring to FIG. 3 (B), for an incompletely divisible problem, the model is divided into k uncorrelated sub-models and each sub-simulation cannot be executed until all the variables of the related sub-model are completely parameterized. Therefore, the sub-simulation of the first sub-model can only be initiated with the parameterization of the second sub-model, and the last sub-simulation (of the k^{th} sub-model) can only be executed after all the variables of k^{th} sub-model are completely parameterized. After the sub-simulations of all the k sub-models are done, a synthesis simulation needs to be executed to synthesize the results of k sub-simulations. The time required for the synthesis simulation, denoted as STex (external simulation), and its corresponding overhead, denoted as OHex (external overhead), need to be included to obtain the total time required for the simulation of an incompletely divisible problem:

$$\begin{matrix}{TT}_{icd} = {\sum }_{j = 1}^{k} max \{ {\sum }_{i = 1}^{{m}_{j}} {pt}_{ji} , {\sum }_{i = 1}^{{m}_{j}} {gt}_{ji} , ( {st}_{j - 1} + {ot}_{j - 1 } ) \} + \\ {st}_{j} + {ot}_{j} + {ST}_{ex} + {OH}_{ex} \\ = {\sum }_{j = 1}^{k} {\sum }_{i = 1}^{{m}_{j}} {pt}_{ji} + {st}_{j} + {ot}_{j} + {ST}_{ex} + {OH}_{ex} \\ = PT + {ST}_{ex} + {OH}_{ex} + {st}_{k} + {ot}_{k} ,\end{matrix} \qquad ( 17 )$$

Where k equals to the number of sub-models and mⱼ equals to the number of variables of the j^{th} sub model. The above equation can be written as:

TT_{icd}=TT_{cd}+STₑₓ+OHₑₓ+stₖ+otₖ (18)

Referring to FIG. 3 (C), in the case of indivisible problems, the simulation cannot be initiated until all the variables have been parameterized. But it is different than traditional simulation where only one random number is realized in each trial for a model variable after the entire parameterization is completed, a random number tuple (RNT) with the required number of random numbers and embedded correlations (if any) will be generated for each model variable right after this model variable has been parameterized. m RNTs will be saved in the same location in the persistent storage (hard disk) of a memory system. When simulation is executed after all model variables have been parameterized and all random numbers have been generated, a RNT will be read from the storage only one time and thus only one instance of overhead time is counted. The above process determines the total simulation time required for indivisible problems:

$$\begin{matrix}{TT}_{ind} = {\sum }_{i = 1}^{m} max \{ {pt}_{i} , {gt}_{i} \} + ST + OH \\ = {\sum }_{i = 1}^{m} {pt}_{i} + ST + OH \\ = PT + ST + OH\end{matrix} \qquad ( 19 )$$

Where m is the number of model variables. According to equation (17), the total simulation time ST can be written as:

$$ST = {ST}_{in} + {ST}_{ex} = {\sum }_{j = 1}^{k - 1} {\sum }_{i = 1}^{{m}_{j}} {st}_{ji} + {st}_{k} + {ST}_{ex} \qquad ( 20 )$$

Where STin means the internal simulation time for k sub-simulations. Similarly, the total overhead time can be written as:

$$\begin{matrix}OH = {OH}_{in} + {OH}_{ex} \\ = {\sum }_{j = 1}^{k - 1} {\sum }_{i = 1}^{{m}_{j}} {ot}_{ji} + {ot}_{k} + {OT}_{ex}\end{matrix} \qquad ( 21 )$$

Then

$$ST + OH = {ST}_{ex} + {OH}_{ex} + {st}_{k} + {ot}_{k} + {\sum }_{j = 1}^{k - 1} {\sum }_{i = 1}^{{m}_{j}} ( {st}_{ji} + {ot}_{ji} ) \qquad ( 22 )$$

Finally the total simulation time required for indivisible problems can be rewritten as:

$${TT}_{ind} = {TT}_{icd} + {\sum }_{j = 1}^{k - 1} {\sum }_{i = 1}^{{m}_{j}} ( {st}_{ji} + {ot}_{ji} ) \qquad ( 23 )$$

Referring to FIG. 3 (D), using the traditional probabilistic simulation method, such like Monte Carlo simulation, the random number generation process and simulation won't be started until all the model variables have been parameterized. Simulation is then divided into n trials, wherein one random number is generated for each model variable in each simulation trial. The generated random numbers of m variables will then be used to perform one simulation and yield one result of the model. This process will be repeated for n times and statistical inferences may be made upon n simulation results. To be noted, each trial requires one instance of overhead time and thus the total overhead time needed for traditional method is n*OH, where OH is the overhead time for one simulation trial. Therefore, the total time required for traditional method can be given by:

TTₜᵣₐ=PT+GT+ST+n×OH (24)

Which can be rewritten as:

TTₜᵣₐ=TT_{ind}+GT+(n−1)OH (25)

Referring to Table 1, the total simulation times needed for different problems and approaches are summarized. Table 1 also compares the delta between two approaches.

TABLE 1
Total simulation time required by different simulation approaches

| # | Method | Time | Incremental to previous |
|---|---|---|---|
| 1 | Complete | PT | N/A |
| | Divisible | | |
| 2 | Incomplete | PT + STₑₓ + OHₑₓ + stₖ + otₖ | STₑₓ + OHₑₓ + stₖ + otₖ |
| | Divisible | | |
| 3 | Indivisible | PT + ST + OH | ${\sum }_{j = 1}^{k - 1} {\sum }_{i = 1}^{{m}_{j}} ( {st}_{ji} + {ot}_{ji} )$ |
| 4 | Traditional | PT + GT + ST + n × OH | GT + (n − 1)OH |

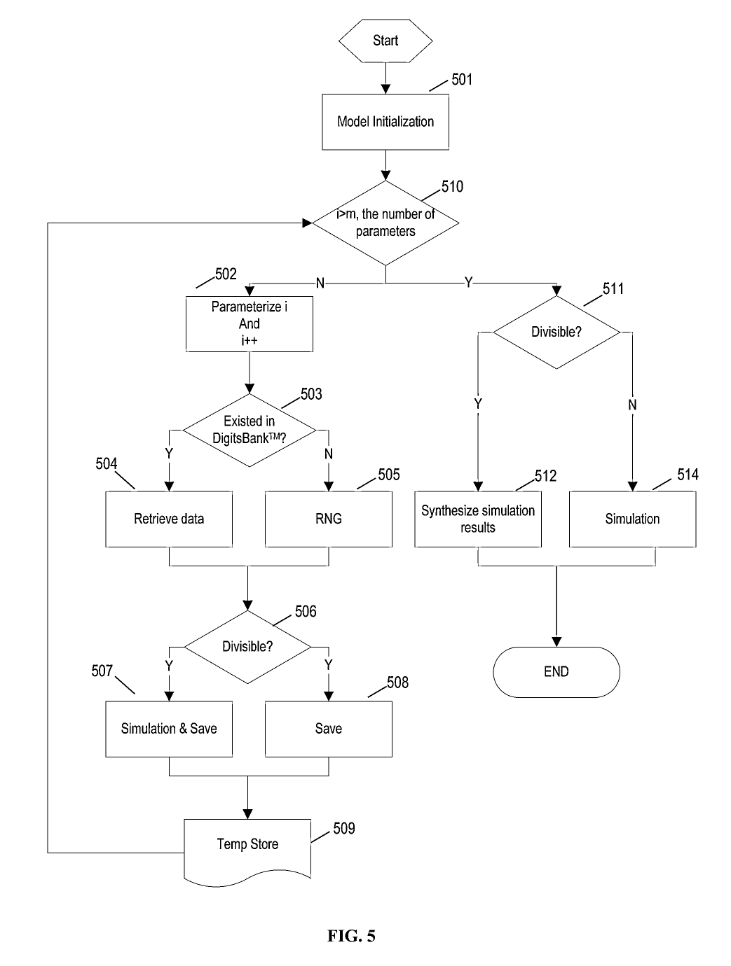

Referring to FIG. 4, a computer implemented system 400 includes a DigitSource™ 401 which contains true random numbers generated by physical processes such as Quantum 402; a DigitBank™ 403 that stores user's history of parameterized models, model inputs and model simulation outputs; a Model Evaluation module 404 that assigns the modeling, parameterizing and updating tasks to the other modules, and divides an entire problem to a set of sub-problems for enabling parallel and instant computation using grid computing; a distribution filter 405 that can converted uniformly distributed random numbers to random numbers that follow arbitrary distributions; a Temporary storage or cache 406 that stores the sub-models and corresponding variables; a Cloud based Grid Computing facility 407 that finish the computing tasks assigned; a Synthesizing module 408 that synthesizes the simulation results of sub-problems; a benchmarking module 409 that aggregates the input and/or simulation results of the users per approval, and benchmark and display a particular model/organization/domain in terms of the uncertainty and risk level per request; and finally a web based user interface 410 which is either in tabular or click-and-point format.

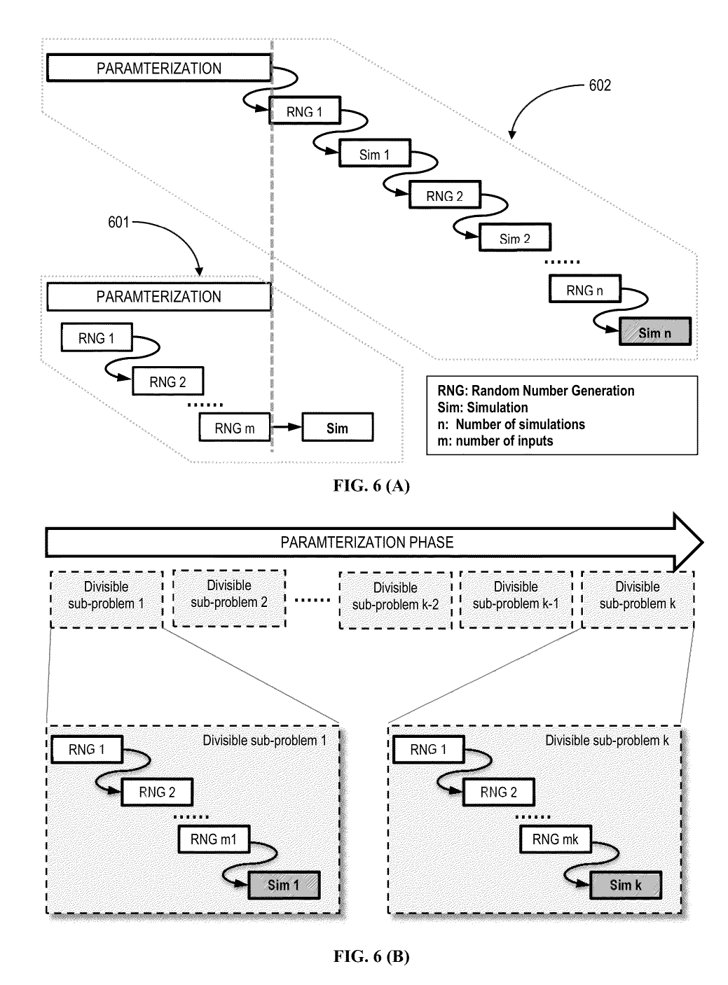

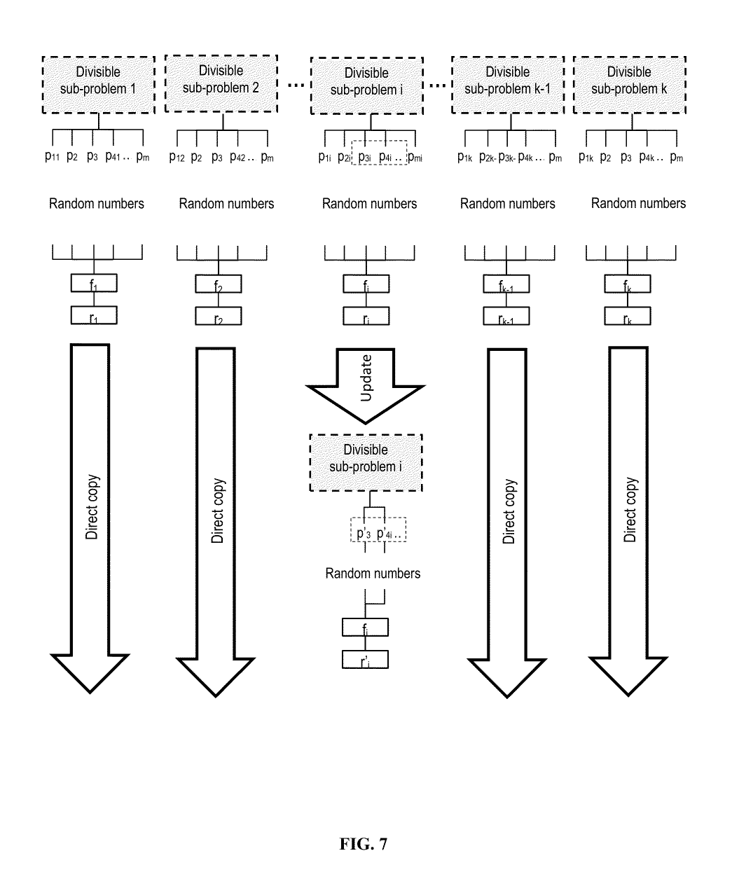

Referring to FIG. 5, a computer implemented process is: the user first defines 501 the model for a given problem P through the web based UI. According to equation (1), the model is denoted as F which converts P into its simulation result R. Once the user completes the definition of F, the model information F is then sent to the Model Evaluation module. Then the user parameterizes 502 at least one model variable (a random variable), which will be sent to the Model Evaluation module instantaneously. After receiving the distribution parameters (parameterization), the Model Evaluation module will first check 503 to see if there are existing random number tuples (RNTs) in the DigitBank™ that are obtained from past modeling and simulation, and follow the defined distribution. If any such existing tuple is found, Model Evaluation module will move 504 the RNTs to the temporary storage or cache for future computation. If there is no existing RNTs that follows the defined distribution, Model Evaluation module utilizes the source random numbers, called DigitSource™, to generate 505 random numbers following the defined distribution and saves them as RNTs in the temporary storage or cache for future computation. DigitSource™ stores at least 10 billion uniformly distributed true random numbers which are generated from physical processes such as, for example, quantum devices. The uniformly distributed true random numbers will be converted into random numbers that follow arbitrary distributions through a Random Number Filter, based on existing random number generation methods such as reverse F method, Acceptance-Rejection method, Markov Chain Monte Carlo method and other methods that will be developed in the future. The requests from the users, depending on the model and specific model variables, will be mapped into particular addresses of DigitSource™, which will later feed the true random numbers to the Random Number Filter to produce random numbers that follow the given distribution. In order to increase the reusability of random numbers, an index will be built and a piece of address information that maps the user request into a particular address of DigitSource™ may be bound to the model and parameterization which will be saved in the DigitBank™. True random numbers saved in the DigitSource™ may be updated regularly but the index entry or mapping addresses of a particular user or particular model won't be changed to maintain consistency. Referring to FIG. 6 (A), the above proposed processes 601 are executed instantaneously in parallel as the user is doing the model initialization and parameterization without any interruptions; while traditional process 602 requires the entire parameterization process to be completed to move to the RNGs. The model information and variable information, once parameterized, will be sent to the temporary storage or cache for an efficient future computation.

[7 Cloud computation] Referring to FIG. 5 again, in prior to the parameterization process, the Model Evaluation module will determine 506 if the problem P is divisible. From the perspective of practical application, divisible problems have at least two independent parts (sub-problems) such that each part can be simulated independently and the results can be synthesized later. If the problem P is incompletely divisible, simulation process 507 begins as soon as executable sub-problem is parameterized completely, i.e., to perform RNGs and Simulations concurrently, which leads to additional efficiency. FIG. 6 (B) illustrates this process. In this case, the sub-model, which corresponds to the sub-problem and corresponding parameters that have been saved in the temporary storage or cache previously, will be sent to the Cloud Computing module. The sub-model will be further divided and parallel computation will be executed in the grid. When a sub-simulation is done, the temporary simulation outputs will be saved 507 in the temporary storage or cache 509. For example, when the m₁ variables of sub-problem 1 have been parameterized, a simulation (sim 1) will be executed immediately on the grid for sub-model 1. Be noted that sim 1 occurs when the user is still parameterizing the second sub-model for p₂. The parameterization process is executed in parallel with the RNG processes and simulation processes. This process will continue until the entire problem or divisible part of the problem is simulated. If the problem is not dividable at all, then the parameterized information will be saved 508 in the temporary storage or cache 509 for future usage.

If the problem is completely divisible, each variable of the problem will be ready for a simulation 507 after the user parameterized and defined at least two variables of the model. The basic unit of simulation occurs between two variables. The user experience would be: after the user defined and parameterized the first two variables, a simulation 507 will start immediately in the cloud based grid computing facility while the user is parameterizing the third variable, and result will be saved 507 as a random number tuple for variable 1 and 2, and RNT_{1&2}. Then the random tuple of the third parameterized variable, or RNT₃, will be aggregated with RNT_{1&2}, which gives RNT_{1&2&3}, while the user is still parameterizing the fourth variable. This process will be repeated until RNT_{1&2&3& . . . &M} is obtained, when the user is very much likely just done with the parameterization of the last variable M. This process is called “Simulate As You Operate” or “SAYO”. The prerequisite of a perfect SAYO is a linear model, or in other words, for any variable i and 1+1, it is possible to perform a simulation. If not, the random number tuple for variable i, or RNTi, can be saved until it is can be simulated. Another special case of SAYO is: for any variable i, the simulation depends on variable p and q, where q>p and p−i>1. Then a simulation can be performed between variable i and p first as an interim simulation. When RNT of q is ready, the result from the temporary simulation will be updated. What is worth noting is all the interim simulation and updating processes are executed concurrently in parallel with the user parameterization process.

If the problem has a nested structure, referring to equation (13), P_{δ} will first be defined and parameterized, and then the lower level relative of P_{δ} will be simulated based on the outcomes of P_{δ}. This process will be repeated in parallel with the model definition and parameterization process without any interruptions until the bottom level P_{α} has been defined, parameterized and simulated. The real-time simulation for nesting problems is realized.

For divisible problems, including completely divisible and incompletely divisible, if all the model variables has been simulated determined by a conditional judgment 510, the temporary simulation outputs will be synthesized 512 to the final simulation result.

If the problem is indivisible determined by a conditional judgment 511, then the simulation 513 cannot be executed until the entire parameterization process is completed. In this case, a “Batch Generation Batch Computation” or “BGBC” strategy will be utilized to increase the efficiency. Referring to FIG. 6 (A) 601, BGBC means that all the required random number tuples are generated in parallel with user parameterization process; and all the random number tuples are prepared all together before the simulation. Once the parameterization is completed, the request of simulation is sent to Cloud based Grid computing module automatically, where simulation is performed. When simulation starts, matrix operations will be conducted instead of arithmetic operations. For any given F wherein matrix operations are not allowed, the elements of the batch generated RNTs will be read one by one to perform the simulation. When the simulation is done, the results are synthesized by the synthesizing model and returned to the user interface. Meanwhile, the user may opt-in DigitBank storage, by which the model information, variable information and simulation results will be sent to the DigitBank, with the corresponding RNTs or true random number address information on DigitSource to increase the reusability of model and/or data. By BGBC, the computational overhead for simulation and database operation such like indexing data, saving data and address initialization, transferring data between CPU and memory system or among different levels of the memory system will be significantly reduced. According to equation (25), it saves (n−1)*OH compared to traditional simulation method.

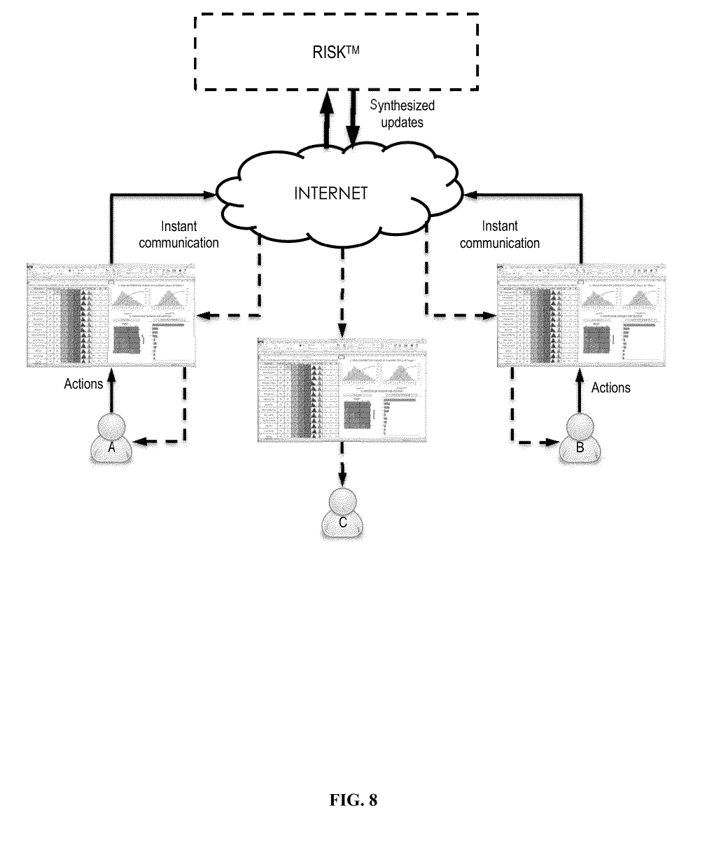

The users may select to modify only part of the model, such as the cases in, for example, a what-if scenario analysis. In this case, RISK™ will hold the model information such as random number tuples used in the simulation and the simulation results of unaffected part of the model fixed, and only repeat the process described in FIG. 5 on the affected part of the model. The final results will be synthesized to reflect the change in state of the model. Referring to FIG. 7, for example, if a problem can be projected into k sub-problems, and each sub-problem is embedded in a pᵢ dimensional space (Formulas 1 and 2), when the user changes n, variables of sub-problem i (nᵢ<=pᵢ), RISK™ only updates nᵢ variables of sub-problem i and correspondingly update the simulation results of sub-problem i and returns the updated results to the temporary storage or cache, but hold the other sub-problems fixed. The updated result of the affected sub-problems will be synthesized with the existing results of the unaffected sub-problems:

$${p}_{i} ∈ {ℜ}^{mi} {\to }^{model update} {p}_{i}^{′} ∈ {ℜ}^{{m i}^{′}} , \\ where {ℜ}^{m i} {\to }^{update n parameters} {ℜ}^{{m i}^{′}} \qquad ( 26 )$$

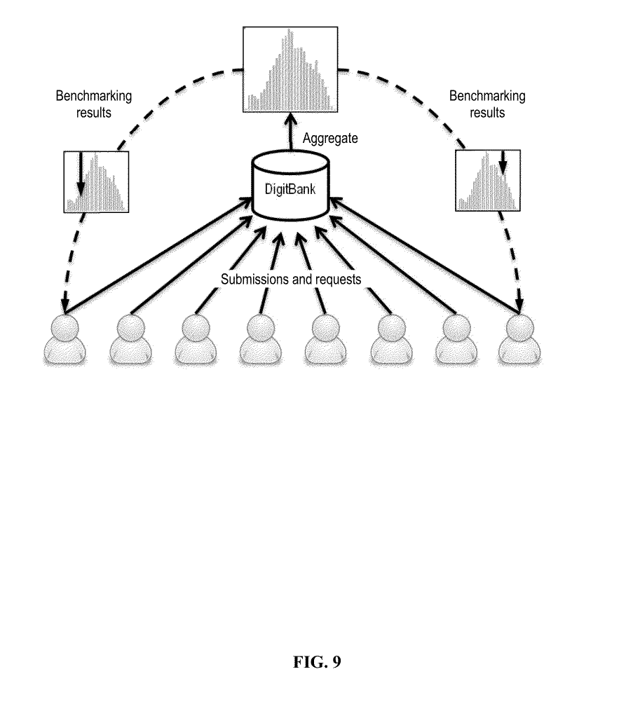

Referring to FIG. 8, users at different sites or different organizations may perform WYSIWYG simulations on RISK™ inter-locationally and inter-organizationally. For example, a company has a remote office which is located in a distant location than the home office. A home office analyst A initiated a collaborative simulation project with the analyst B who is at the remote office. A may start a simulation project and share the simulation model template with B so A and B are able to work together on the same model. Any changes initiated by A or B to the model will be sent to RISK™ instantaneously through computer networks such as, for example, the internet. RISK™ will perform the RNGs, RNT retrieval, model evaluation and searching and cloud computation of the model or sub-models instantly as the process described in FIG. 5. The updates of model states, if any, will be synthesized by RISK™, and sent to the web-based user interfaces instantaneously. As a result, A and B will be able to see the changes they made as well as the updated model state immediately after the changes are made. Meanwhile, another user C may select to be the observer of the modeling and simulation process, he/she may be granted the read-only or viewing right instead of update rights by A to observe. Beyond updating and read-only rights, other rights, such as overriding results, moving/deleting models, creating databases for models, can be granted or revoked by the system admin as per predetermined security policies.

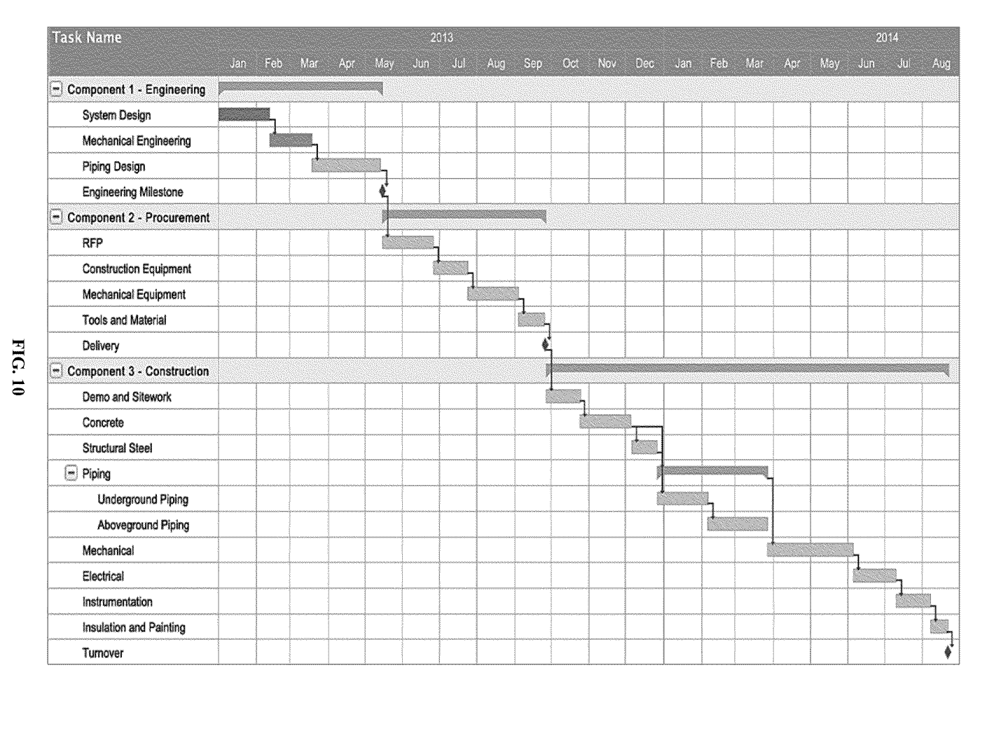

Referring to FIG. 9, the users may opt into a process of sharing and benchmarking the model-associated statistics. Once a simulation project is done on RISK™, the user may select to publish the results including generic background information, model inputs, model information and model simulation outputs by submitting relevant information the DigitBank. DigitBank will aggregate the submitted information and calculate statistics of interest including but not limited to: model input PDFs, the mean values and standard deviation values of model inputs and outputs, the maximum and minimum values of model inputs and outputs, percentile values of model inputs and outputs, number of input and/or output variables, simulation time, industry or domain (such as financial, retailing, construction, and academia etc), geographic information (such as the location of the business). For very specific simulation projects, such as project schedule PERT simulation, the calculated statistics may include those that of particular interests of that domain such as project duration, duration uncertainty etc. This enables the user to benchmark his/her results against all the submitted results. A typical example may be the percentile of the project risk level in a project schedule PERT simulation, shown as the simulated duration uncertainty of the project; or the percentile of the expected return in a stock investment portfolio simulation; or simply the rank of counts of the simulated stocks. A set of filters may be set so the user can query and focus only on the interested areas or aspects.

There is a statistical analysis module and process built in RISK™ to enable in-database or expert involved backstage in-depth statistical analysis. On the one hand, the user may submit specific and straight statistical analysis requests to RISK™, such as time series analysis, regression analysis, classification analysis, clustering analysis. The statistical analysis may be based on a probabilistic model and can hardly be realized using existing commercial software. For example, a user may want to build a regression model to predict the revenue (Y) based on prices of the several products (X₁, X₂, . . . , Xₘ) and corresponding sales amount (Xₘ₊₁, Xₘ₊₂, . . . , Xₙ, where n=2m). Be noted that different than a regular regression analysis where Y and X's are given, the information the user has might be PDFs of X's and corresponding correlation coefficients. If the PDFs of X's are not symmetric, then finding out the regression model f for Y=f(X₁, X₂, . . . , Xₙ) may be a nontrivial task, not to mention correlations may exist among X's. In many cases, latent variables may be needed in such a regression analysis such as the standard deviation of an X. Using existing commercial statistical software the analysis of this type of problems involves generating samples following the provided PDFs and correlation coefficients and fitting models repeatedly. RISK™ utilizes existing RNTs or completed RNGs to perform the regression analysis which is more efficient. RISK™ utilizes the submitted model information such as model inputs and simulation outputs to perform in-database statistical analysis and returns the results to the user instantaneously. On the other hand, if other in-depth statistical analysis requests are beyond the capacity of the model, requests will be sent to experienced statistician to perform back-stage analysis and return the results to the system which will later return the results to the user. For the above two cases, the statistical analysis is done in the system. Specific information pertaining to the model will be hidden from any human involved process to ensure the confidentiality.

The web-based user interface is realized not only on personal computers, but also on portable devices including but not limited to, smart phones, tablets, watches, calculators, Google glasses and etc. The model parameterizing process can be realized by multiple input methods such as touch screen, scanning, voice input and etc. Simulation process is done on Cloud based remote severs and results are returned to the user interfaces as numbers, graphs, colors, and sounds etc. Attributed to the processes discussed hereinabove, the model initialization, model parameterization and model simulations are done concurrently and remotely, WYSIWYG simulation is enabled in portable devices.

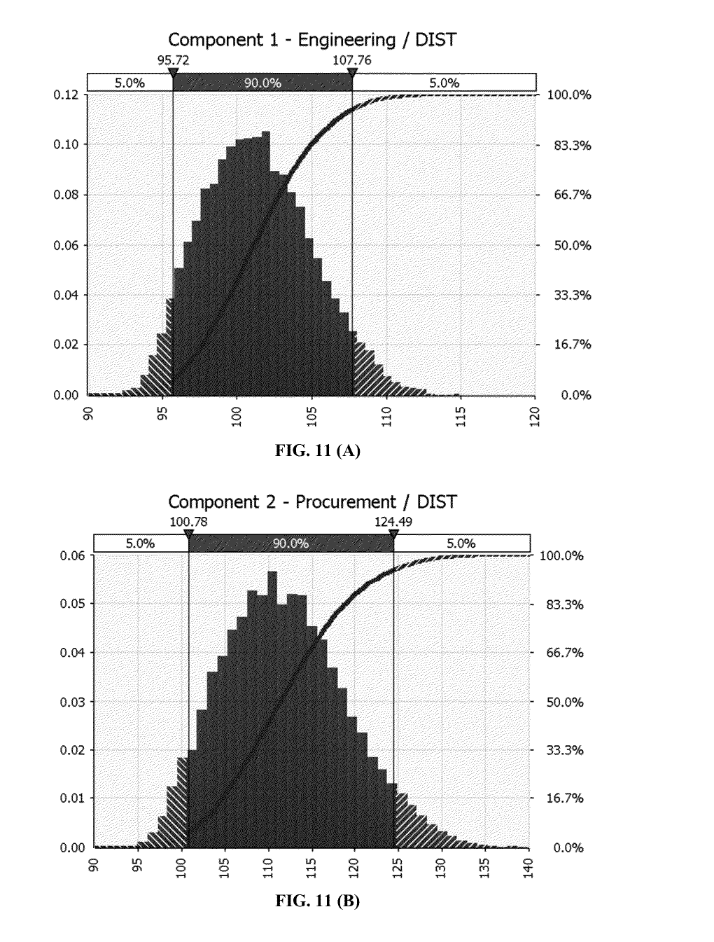

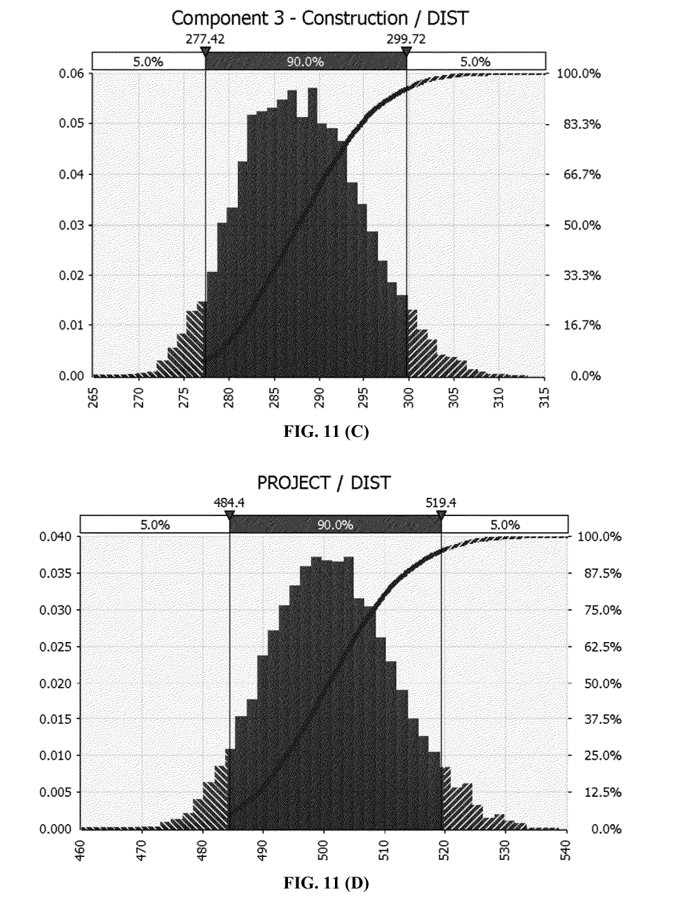

A specific implementation of RISK™ may be used to perform PERT simulation of project schedules. Referring to FIG. 10 scheduling belongs to a divisible problem. A schedule can be divided by major milestone, sections, WBS structures and other classification categories. The example shows an EPC (Engineering, Procurement and Construction) project that can be divided into three major components respectively Engineering, Procurement and Construction. When a scheduler inputs variable for the first activity, system design, RISK™ starts to generate random numbers for this activity instantly, and copy the generated random number tuple to the temporary storage or cache on RISK™. Similarly, when the scheduler completes the input of the second activity, “Mechanical Engineering”, RISK™ starts the RNG for it. As discussed above, the RNG may be overwritten by a data retrieval process if the parameterized variables existed in the database. For example, if the duration of “System Design” follows a Triangular distribution (75%*Baseline, Baseline, 125%*Baseline) which has been defined previously, or stored in DigitBank as a default RNT, then the corresponding random number tuple will be copied into the temporary storage or cache on RISK™. This process will continue until the scheduler completes the input of the entire Component 1—Engineering, marked as a milestone named “Engineering Milestone”, a sub-simulation is initiated backstage on the Cloud based grid computation module of RISK™ for Component 1—Engineering, while the scheduler maybe inputting the variables for Component 2—Procurement at the same time. Once the first sub-simulation is done, result will be saved in the temporary storage or cache on RISK™ as a tuple of random numbers for the duration of Component 1—Engineering. Because the problem is divisible, this tuple, as a synthesized result for Component 1—Engineer, can be used to represent all the Engineering activities, referring to FIG. 11 (A). The random number tuple representing the simulation result of Component 1—Engineering, as shown in FIG. 11 (A), is stored in the temporary storage or cache. The above process will be repeated until the entire project has been parameterized, randomly generated and simulated, including Component 2—Procurement and Component 3—Construction. Correspondingly the simulation results represented as random number tuples as shown in FIG. 11 (B) and (C) are stored in the temporary storage or cache of RISK™. Three random number tuples of three components of the schedule are synthesized (additive operation in this case) and the final result is displayed immediately after the scheduler parameterized the last activity, “Insulation and Painting”, as the RNGs and simulation process has been completed with the parameterization process, as shown in FIG. 11 (D).

The scheduler may want to change the variables of one or more activities in a “What-if Scenario” Analysis. In this case, only the random number tuples of the affected activities on DigitsBank will be changed, while others may remain unchanged. Correspondingly, only the affected part of the schedule will be re-simulated, while the simulation results of unaffected sub-schedules will remain the same as they have no dependencies amongst each other. The updated sub-simulation will be synthesized later. In this way, there is no need to re-generate random number tuples for unaffected part of the schedule, or repeat the sub-simulations for them and greater efficiency is achieved. A great deal of system resource may be saved and the efficiency of a “What-if Scenario” analysis will be greatly improved compared to traditional Monte Carlo simulation where RNGs and simulations need to be repeated all the time regardless of the fact that only a part of the problem is updated.

For example, originally “Mechanical” and “Above ground piping” follow a triangular distribution (0.95*baseline, baseline, 1.25*baseline). In a “What-if Scenario” analysis the scheduler decided to examine the impacts of these two activities if they have bigger chance of slipping and follow a new triangular distribution (0.95*baseline, baseline, 1.50*baseline) for them. By updating the PDFs for these two activities, only two RNTs are changed on RISK™, corresponding to “Mechanical” and “Above ground piping”, while all the RNTs associated with other activities and the output RNTs of Component 1—Engineering and Component 2—Procurement remain unchanged since no changes occur to them. The updated RNTs of “Mechanical” and “Above ground piping” will then be synthesized (in this case it is an additive operation) with other RNTs of other “Construction” activities to generate updated RNT of Component 3—Construction, referring to FIG. 11 (E). The updated RNT of Component 3—Construction will then be synthesized (in this case it is an additive operation) with RNTs of Component 1—Engineering and Component 2—Procurement to generate updated RNT of the entire project which can be used for statistical inference, referring to FIG. 11 (F). Because a great deal of steps has been skipped using RISK™ process, the “What-if Scenario” analysis becomes real-time and allows better communication and decision-making.

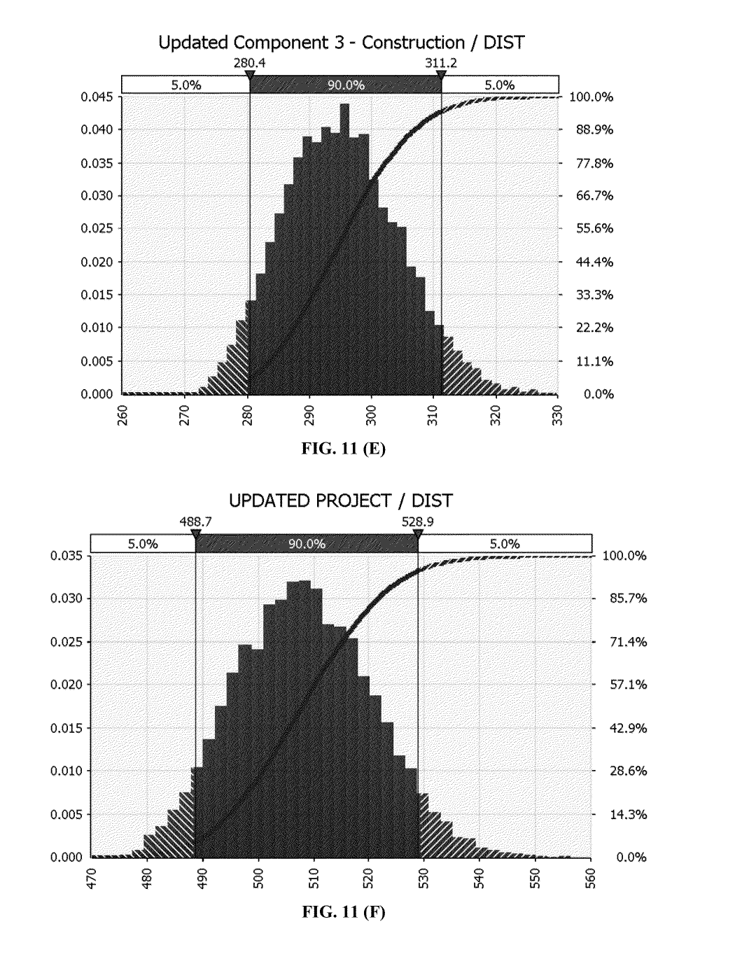

The scheduler may also want to start a collaborative schedule simulation project with colleagues at different sites. By the process described in FIG. 8, users at different locations may access the same model and edit the model and model variables concurrently. Updates to model and model variables are shown instantaneously in a WYSIWYG fashion for all the participants, as shown in FIG. 12. Each participant may have the same right to trigger the simulation; otherwise, the right of a participant may be determined and granted by the system administrator.

The scheduler may also select to benchmark the level of uncertainty of the schedule, in a sense of the project duration uncertainty or average uncertainty of individual activities. The scheduler needs to opt in for a benchmarking function, which requests the submission of the simulation results. Once the results are submitted to RISK™, an aggregation calculation is started and the relevant benchmarking result is returned, such as percentile and other indices that may be developed later. The submitted simulation results will also become a part of the benchmarking database, or RiskCloud™, which keeps updating while more information is submitted and aggregated.

If the schedule doesn't contain any milestones, it might be difficult to divide it into components. In this case, the schedule simulation can still be integrated with the model initialization and parameterization processes on RISK™ by using “Simulate As You Operate” (SAYO) method.

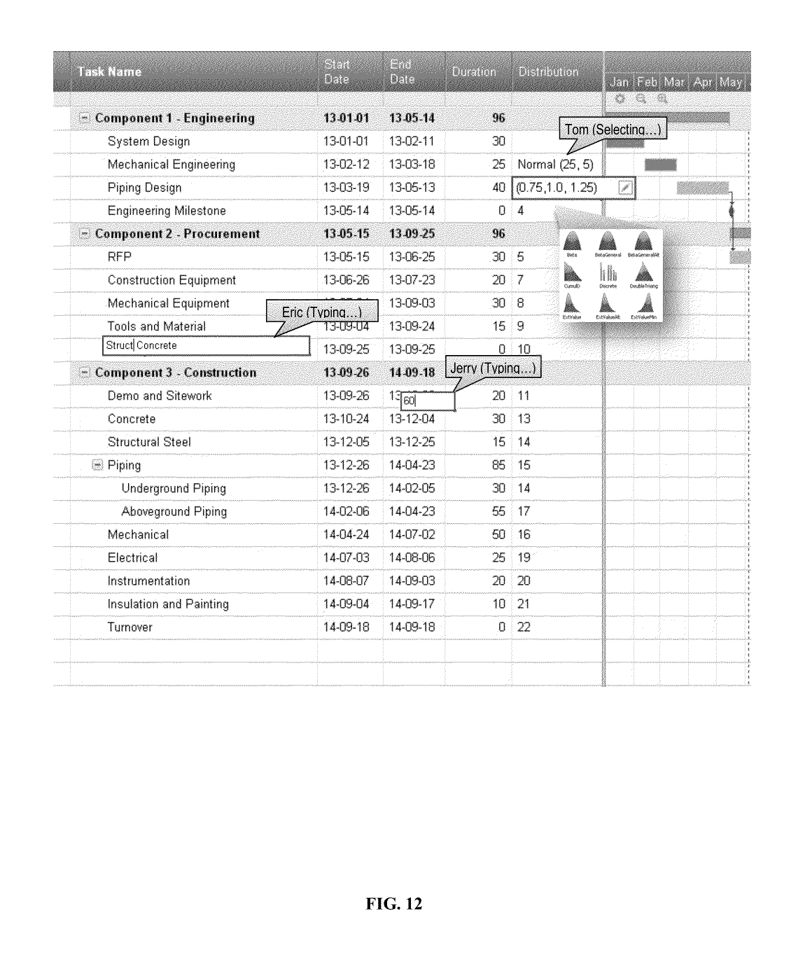

Referring to Table 2, under SAYO each activity has three tables or random number tuples associated with them and saved on RISK™, namely duration RNT (RNT_{ACTIVITY}), starting date RNT (RNT_{ACTIVITY/S}) and finish date RNT (RNT_{ACTIVITY/F}), which may contain, for example, 1,000 random numbers each. Referring to FIG. 13, a simple schedule has only five activities (A, B, C, D and E) but has no milestones. Suppose the schedule starts on Jan. 7, 2013. A random number tuple for the starting date of activity A (RNT_{AS}) is generated immediately, although this date may be fixed. After the scheduler parameterized distribution of activity A, a random number tuple for the duration of activity A (RNT_{A}) is generated instantly, and immediately, a random number tuple for the finish date of activity A (RNT_{AF}) is calculated by (RNT_{AS}+RNT_{A}). According to the logic ties between A and B, and A and D, RNT_{AF} will be transferred to B and C as their random number tuples of start dates respectively, namely RNT_{BS} and RNT_{DS}. Following the same logic, RNT_{B}, RNT_{BF}, RNT_{CS}, RNT_{C}, RNT_{CF}, RNT_{D}, RNT_{DF} are transferred, generated and calculated, while the scheduler is still parameterizing and modeling the schedule. The random number tuple RNT_{ES} equals to the maximum of RNT_{CF} and RNT_{DF} and thus a maximum calculation is done and RNT_{ES} is obtained. RNT_{EF}, which is also the random number tuple of the project finish date is then calculated by RNT_{ES}+RNT_{E}. Because all the critical random number tuples have been generated, transferred and calculated concurrently when the scheduler is parameterizing and modeling the schedule, the final project completion date distribution will be obtained immediately after the scheduler parameterized activity E. The real time schedule simulation is realized.

TABLE 2
Random number tuples for the sample schedule

| | A | | | B | | | C | | | D | | | E | | |
|---|---|---|---|---|---|---|---|---|---|---|---|---|---|---|---|
| | Start | Dur | Finish | Start | Dur | Finish | Start | Dur | Finish | Start | Dur | Finish | Start | Dur | Finish |
| Trials | (RNT_{AS}) | (RNT_{A}) | (RNT_{AF}) | (RNT_{BS}) | (RNT_{B}) | (RNT_{BF}) | (RNT_{CS}) | (RNT_{C}) | (RNT_{CF}) | (RNT_{DS}) | (RNT_{D}) | (RNT_{DF}) | (RNT_{ES}) | (RNT_{E}) | (RNT_{EF}) |
| 1 | Jan. 7, | 9 | Jan. 16, | Jan. 16, | 5 | Jan. 21, | Jan. 21, | 7 | Jan. 28, | Jan. 16, | 14 | Jan. 30, | Jan. 30, | 3 | Feb. 2, |
| | 2013 | | 2013 | 2013 | | 2013 | 2013 | | 2013 | 2013 | | 2013 | 2013 | | 2013 |
| 2 | Jan. 7, | 8 | Jan. 15, | Jan. 15, | 5 | Jan. 20, | Jan. 20, | 11 | Jan. 31, | Jan. 15, | 14 | Jan. 29, | Jan. 31, | 4 | Feb. 4, |
| | 2013 | | 2013 | 2013 | | 2013 | 2013 | | 2013 | 2013 | | 2013 | 2013 | | 2013 |
| 3 | Jan. 7, | 11 | Jan. 18, | Jan. 18, | 7 | Jan. 25, | Jan. 25, | 10 | Feb. 4, | Jan. 18, | 13 | Jan. 31, | Feb. 4, | 4 | Feb. 8, |
| | 2013 | | 2013 | 2013 | | 2013 | 2013 | | 2013 | 2013 | | 2013 | 2013 | | 2013 |
| 4 | Jan. 7, | 9 | Jan. 16, | Jan. 16, | 7 | Jan. 23, | Jan. 23, | 8 | Jan. 31, | Jan. 16, | 14 | Jan. 30, | Jan. 31, | 5 | Feb. 5, |
| | 2013 | | 2013 | 2013 | | 2013 | 2013 | | 2013 | 2013 | | 2013 | 2013 | | 2013 |
| 5 | Jan. 7, | 11 | Jan. 18, | Jan. 18, | 7 | Jan. 25, | Jan. 25, | 6 | Jan. 31, | Jan. 18, | 13 | Jan. 31, | Jan. 31, | 5 | Feb. 5, |
| | 2013 | | 2013 | 2013 | | 2013 | 2013 | | 2013 | 2013 | | 2013 | 2013 | | 2013 |
| 6 | Jan. 7, | 9 | Jan. 16, | Jan. 16, | 7 | Jan. 23, | Jan. 23, | 7 | Jan. 30, | Jan. 16, | 17 | Feb. 2, | Feb. 2, | 6 | Feb. 8, |
| | 2013 | | 2013 | 2013 | | 2013 | 2013 | | 2013 | 2013 | | 2013 | 2013 | | 2013 |
| . . . | . . . | . . . | . . . | . . . | . . . | . . . | . . . | . . . | . . . | . . . | . . . | . . . | . . . | . . . | . . . |
| 998 | Jan. 7, | 11 | Jan. 18, | Jan. 18, | 5 | Jan. 23, | Jan. 23, | 9 | Feb. 1, | Jan. 18, | 13 | Jan. 31, | Feb. 1, | 3 | Feb. 4, |
| | 2013 | | 2013 | 2013 | | 2013 | 2013 | | 2013 | 2013 | | 2013 | 2013 | | 2013 |
| 999 | Jan. 7, | 11 | Jan. 18, | Jan. 18, | 6 | Jan. 24, | Jan. 24, | 11 | Feb. 4, | Jan. 18, | 15 | Feb. 2, | Feb. 4, | 7 | Feb. 11, |
| | 2013 | | 2013 | 2013 | | 2013 | 2013 | | 2013 | 2013 | | 2013 | 2013 | | 2013 |
| 1000 | Jan. 7, | 8 | Jan. 15, | Jan. 15, | 5 | Jan. 20, | Jan. 20, | 9 | Jan. 29, | Jan. 15, | 14 | Jan. 29, | Jan. 29, | 8 | Feb. 6, |
| | 2013 | | 2013 | 2013 | | 2013 | 2013 | | 2013 | 2013 | | 2013 | 2013 | | 2013 |

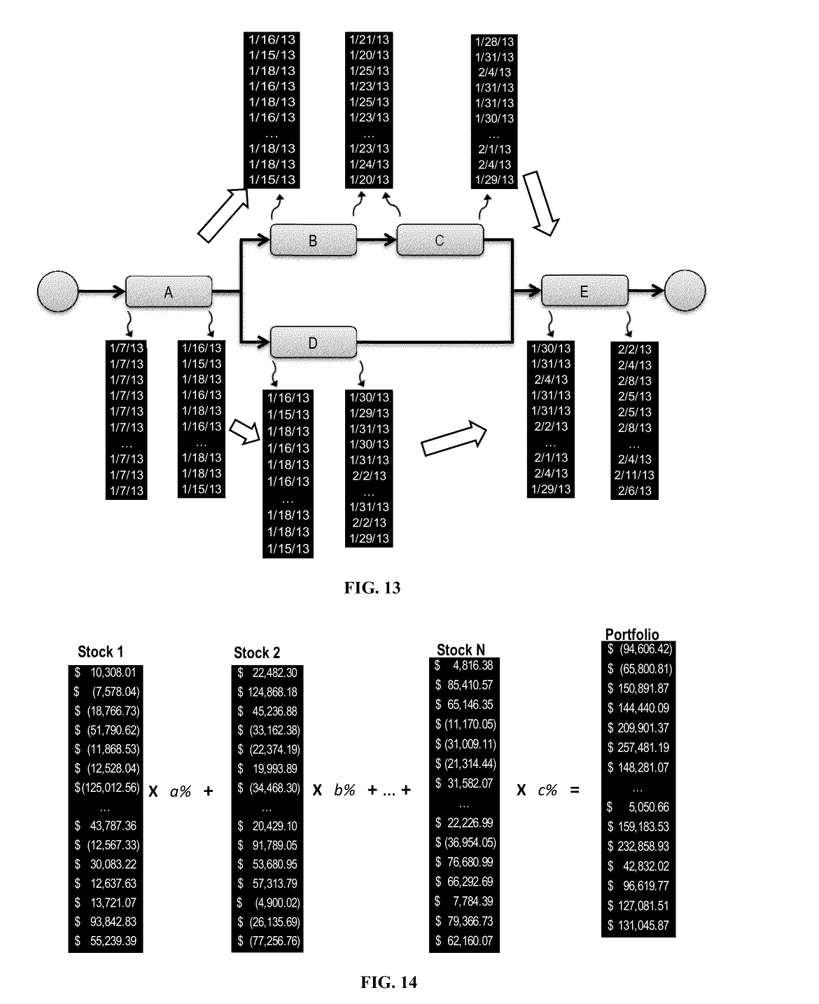

Another specific implementation of RISK™ may relate to investment portfolio analysis. VaR (Value at Risk) is widely used to investigate the risk (especially risk of loss) on an investment portfolio with one or more financial assets over the given time horizon. Traditional calculation of VaR is analytical based, especially using variance-covariance method. But analytical method has certain drawbacks. First, Analytical VaR assumes not only that the historical returns follow a normal distribution, but also that the changes in price of the assets included in the portfolio follow a normal distribution. And this very rarely survives the test of reality. Second, Analytical VaR does not cope very well with securities that have a non-linear payoff distribution like options or mortgage-backed securities. Finally, if our historical series exhibits heavy tails, then computing Analytical VaR using a normal distribution will underestimate VaR at high confidence levels and overestimate VaR at low confidence levels. As an alternative to analytical VaR, Monte Carlo simulation is used. RISK™ can be used to improve the user experience of performing VaR analysis using Monte Carlo simulation, and to realize real-time VaR calculation. Suppose an investor wants to study the investment portfolio with N stocks. RISK™ maintains the PDFs of all commonly used stocks. Referring to FIG. 14, once the user selects a stock, the PDF pertaining to that stock will be retrieved from the database and a random number tuple will be generated to represent all possible returns by investing this stock. The VaR for the stock, as well as other alternatives such as CVaR (Conditional Value at Risk) and EVaR (Entropic Value at Risk), will be calculated and displayed instantaneously under provided time horizon and significance level a. Then the user starts to select the second stock. Similarly, a random number tuple will be generated according to the retrieved PDF to represent possible returns by investing the second stock, and the VaR, CVaR and EVaR for the second stock will be calculated and displayed instantaneously under provided time horizon and significance level a. If there are correlations among stocks, methods for preserving the correlations will be used such as Cholsky decomposition. Moreover, given the relative share of the first stock and the second stock which are provided by the user, an additive operation will be performed between random number tuples of the first and the second stocks' returns. The VaR, CVaR and EVaR of the aggregated random number tuples will be calculated and displayed instantaneously to represent portfolio risk. This process will be repeated for the rest stock selections and the VaR, CVaR and EVaR of the portfolio return will be calculated concurrently and updated on a timely basis, i.e., every time when any part of the portfolio is updated. Once the user finishes the selection of the last stock and the parameterization of the stock share on the portfolio, The VaR, CVaR and EVaR of the entire portfolio will be displayed instantaneously. SAYO is realized.

In another case, the random number tuples may be obtained directly from the stock transaction history. RISK™ acquires stock transaction data from data providers and saves it on DigitBank™. User selects certain stocks and defines the time horizon that is of the interest, for example, transactions of every minute in past 6 months, and then RISK™ will retrieve relevant transaction data from the database and saves it on the temporary storage or cache. The VaR, CVaR and EVaR of each stock and the portfolio will be calculated and updated in a SAYO fashion.

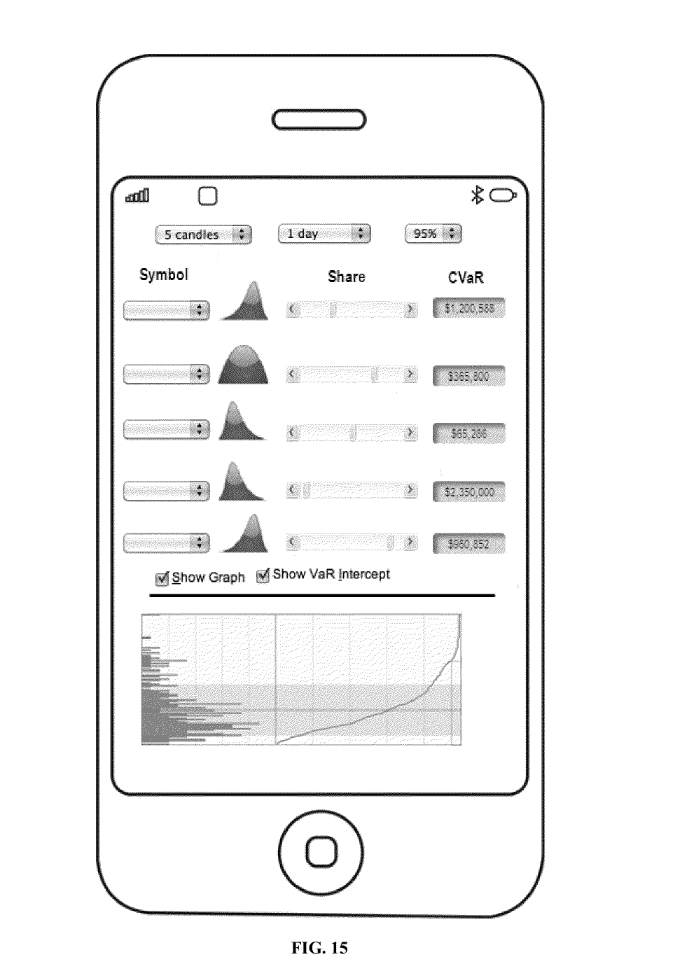

Referring to FIG. 15, Because real-time simulation is realized because of using parallel processing on Cloud based grid computing facility, it is possible to perform investment portfolio analysis on portable devices, such as but not limited to smart phones, tablets, calculators with wife/4G connections, watches and etc.

In another case, the user may want to perform sensitivity analysis to check what stocks are more influential to the portfolio's final return. Instead of the traditional sensitivity analysis method where random numbers are generated for each trial for each model input, and output results are aggregated finally to calculate the sensitivity indices of each input, RISK™ adopts the “batch generation batch computation” (BGBC) strategy. For example, in order to calculate Sobol's total sensitivity indices (TSI), the variance of inputs and outputs need to be calculated repeatedly on a timely fashion. BGBC enables a faster implementation of Sobol's TSI calculation. Sobol's TSI method assumes a nonlinear function can be decomposed to summands of orthogonal increasing order terms which is called ANOVA-representation:

$$f ( {x}_{1} , {x}_{2} , … , {x}_{m} ) = {f}_{0} + {\sum }_{i = 1}^{m} {f}_{i} ( {x}_{i} ) + {\sum }_{{i}_{1} = 1}^{m} {\sum }_{{i}_{2} = {i}_{1} + 1}^{m} {f}_{{i}_{1} {i}_{2}} ( {x}_{{i}_{1}} , {x}_{{i}_{2}} ) + … + {f}_{1 … m} ( {x}_{1} , … , {x}_{m} ) \qquad ( 27 )$$

Assume xᵢ(i=1, 2, . . . m) are independent random variables with probability density functions pᵢ(xᵢ), then the constant term f₀ is determined by:

$${f}_{0} = \int f ( x ) {\prod }_{i = 1}^{m} [ {p}_{i} ( {x}_{i} ) d {x}_{i} ] \qquad ( 28 )$$

Therefore, the general form of k-order term of f(x₁,x₂, . . . , xₘ)(a decomposition term depending on k input variables) is given by:

$${f}_{{i}_{1} {… i}_{m}} ( {x}_{{i}_{1}} , … , {x}_{im} ) = \int f ( x ) {\prod }_{j \neq {i}_{1} , … {i}_{m}} [ {p}_{j} ( {x}_{j} ) d {x}_{j} ] - {\sum }_{k = 1}^{m - 1} {\sum }_{{j}_{1} , … , {j}_{k} ε ( {i}_{1} , … , {i}_{m} )}^{ } {f}_{{j}_{1} , … {j}_{k}} ( {x}_{{j}_{1}} , … {x}_{{j}_{k}} ) - {f}_{0} \qquad ( 29 )$$

A key assumption of Sobol's method is orthogonality, i.e., the terms of f(x₁,x₂, . . . , xₘ) are uncorrelated with each other. As a result, the variance of f(x₁,x₂, . . . ,xₘ) can be determined by:

$$D = {\sum }_{i = 1}^{m} {D}_{i} + {\sum }_{{i}_{1} = 1}^{m} {\sum }_{{i}_{2} = {i}_{1} + 1}^{m} {D}_{{i}_{1} {i}_{2}} + … + {D}_{1 , … , m} \qquad ( 30 )$$

Sensitivity indices are then defined as:

$${S}_{{i}_{1} , … , {i}_{k}} = \frac{{D}_{{i}_{1} , … , {i}_{k}}}{D} \qquad ( 31 )$$

And the summation of all the sensitivity indices equals 1:

$${\sum }_{k = 1}^{n} {\sum }_{{i}_{1} < … < {i}_{k}}^{n} {S}_{{i}_{1} , … , {i}_{k}} = 1 \qquad ( 32 )$$

If k=1, then Sᵢ_{₁}_{, . . . ,i}_{ₖ} is called main sensitivity index (MSI); if k≧2, then Sᵢ_{₁}_{, . . . ,i}_{ₖ} is called interaction sensitivity index (ISI). The total sensitivity index (TSI) is then defined as:

Sᵢ^{tot}=Sᵢ+Ŝ_{i,˜i}=1−Ŝ_{˜i} (33)

Where Ŝ_{i,˜i} is the summation of all the Sᵢ_{₁}_{, . . . ,i}_{ₖ} that involve the index i and at least one index from (1, . . . , i−1, i+1, . . . , m); Ŝ_{˜i} is the summation of all the that do not involve any index therefore represents the average variation in the outputs of the model that is contributable to the input variable i through its sole influences and interactions with other variables. Sobol's TSI requires heavy calculations of variance D and Di. To calculate D and Di, the marginal explained variance of output Y due to newly added X should be calculated recursively, following:

f₀=E(Y) (35)

fᵢ(Xᵢ)=E(Y|Xᵢ)=f₀ (36)

fᵢⱼ(Xᵢ,Xⱼ)=E(Y|Xᵢ,Xⱼ)−f₀−fᵢ−f₁ (37)

Thus, when the user completed parameterizing Xᵢ, fᵢ can be calculated; when the user when the user completed parameterizing Xⱼ, fᵢⱼ can be calculated etc. The calculation process is repeated until f_{1 . . . M} is calculated where M is the dimensionality of problem P. In this way, the calculation of Sobol's TSI is integrated with model definition and parameterization process.

The execution of D and Di computation is described as below: The first step is to generate random number tuples for the input variables. This generation makes use of the best information available on the statistical properties of the input variables. In some instances, it is possible to get empirical data for the input variables. This step follows the RNGs process described in FIG. 5. Completed step 1 we should have input RNTs and it is now necessary to execute the model under analysis. That means that each element of the sample xi=[xi1, xi2, . . . , xin], i=1, . . . , m where n is the number of sampled variables and m the size of the sample, is supplied to the model as input. This creates a sequence of results of the form yi=f(xi1, xi2, . . . , xin)=f(xi). If there are many model predictions of interest, yi would be a vector rather than a single number. Finally, propagation of the sample through the model creates a mapping from analysis inputs to analysis results of the form [yi, xi1, xi2, . . . , xin], i=1, . . . , m, where n is the number of input factors and m is the sample size. Once this mapping is generated and stored, it can be explored in many ways to determine the sensitivity of model predictions to individual input variables. Quasi Monte Carlo method may be utilized to realize a low-discrepancy sequence to improve the efficiency of the estimator.

The method and the apparatus described above can be realized and implemented in any software or hardware environment. It can be integrated with existing simulation software through designed I/O interfaces. It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, system and/or apparatus including one or more concepts of the present invention.

What is claimed is:

1. A method comprising:
Categorizing simulation problems into divisible and indivisible, wherein divisible problems can be further categorized into completely divisible and incompletely divisible;
Using an information apparatus, executing model parameterization, random number generation, simulation and synthesis, wherein said model parameterization not only includes defining the PDFs of model variables but also includes retrieving existing results of the previous random number generations, wherein said random number generation comprises retrieving existing random number tuples that follow the given parameterized PDFs from a database and generating random numbers that follow arbitrary PDFs defined by the user using true random number generators such as quantum random number generators and random number generation methods such as Markov Chain Monte Carlo, and wherein said execution comprises:
Performing the random number generation tasks concurrently in parallel with the user parameterization process for all types of problems including divisible and indivisible;
Projecting an incompletely divisible problem onto k sub-spaces, wherein 2≦k<m, wherein m is the number of model variables, and performing the random number generation tasks and the sub-simulation tasks concurrently with the user parameterization process, wherein a simulation can be executed if only all variables of a sub-model have been parameterized and the corresponding random number tuples have been realized; and the outcomes of k sub-simulations are synthesized to yield the final result after k sub-models have been simulated;
Projecting a completely divisible problem onto k sub-spaces, wherein 2≦k=m, wherein m is the number of model variables, and performing the random number generation tasks and the sub-simulation tasks concurrently with the user parameterization process, wherein a simulation can be executed if at least two variables have been parameterized and the corresponding random number tuples have been realized, or at least a variable has been parameterized and the corresponding random number tuple has been realized to update the simulation outcomes from previous sub-simulations; and the outcome of each sub-simulation is updated with the new parameterized variables until all m model variables have been simulated to yield the final result;
Holding the model information, such as random number tuples used in the simulation and the simulation results of unaffected part of the model fixed if and when only a part of the model is changed, and only repeating the process described above on the affected part of the model; and synthesizing the outcomes to reflect the update to the model;

2. A computer implemented method comprising:
Defining the model through a web-based user interface, wherein said model includes the operations over model variables including arithmetical operations, logic operations, and matrix operations and so on.
Parameterizing the model variables through a web-based user interface, wherein said parameterization includes defining the PDFs of model variables and/or retrieving existing results of the previous random number generations;
Sending the random number generation requests through a computer network, such as internet, to a remote cloud based server in parallel with the model parameterization;
Generating random number tuples on the cloud based remote server in parallel with the model parameterization, wherein said random number generation includes retrieving existing random number tuples from previous random number generations on the remote server, wherein said random number generation may also include generating random numbers that follow arbitrary PDFs defined by the user using true random number generators such like quantum random number generators and random number generation methods such as Markov Chain Monte Carlo on the remote server;
Sending the model and generated random number tuples to a temporary storage space on the remote server, which further sends the model and the random number tuples to a computation unit, such as, cloud based grid computing facility, wherein the simulation will be executed, wherein said simulation includes m−1 sub-simulations for completely divisible problems, wherein m is the number of model variables, or k sub-simulations for incompletely divisible problems, wherein k is the number of sub-models; and synthesizing the outcomes of the sub-simulations on a synthesize module to yield the final result;
Storing the final result on a permanent storage, such as a database on the remote server, and returning the result to the web-based user interface, with the storage information;
Sending the model update requests to the remote server through a web-based user interface, wherein said update comprises changes to model variables and model per se, wherein holding model information such as random number tuples used in the simulation and the simulation results of unaffected part of the model fixed if and when only a part of the model is changed, and only repeating the process described above on the affected part of the model; and synthesizing the outcomes to reflect the update to the model; and storing the updated result on a permanent storage, such as a database on the remote server, and returning the result to the web-based user interface, with the storage information;
Publishing the approved results including generic background information, model inputs, model information and model simulation outputs by submitting relevant information to the remote server, wherein submitted information and calculated statistics of interest will be aggregated including but not limited to: model input PDFs, the mean values and standard deviation values of model inputs and outputs, the maximum and minimum values of model inputs and outputs, percentile values of model inputs and outputs, number of input and/or output variables, simulation time, industry or domain (such as financial, retailing, construction, and academia etc), geographic information (such as the location of the business); and benchmarking a submitted result against all the previously submitted results, wherein a set of filters may be set so the user can focus only on the interested areas or aspects;
Submitting advanced statistical analysis requests to the remote server, wherein requests may be processed by a statistical analysis module or human intervened process, wherein said statistical analysis may be hard to realize using existing commercial software; and returning the statistical analysis to the user interface;
Allowing users at different locations or from different organizations executing part or complete processes as described above on the same model and at the same time according to the pre-assigned authorizations, wherein said authorizations comprises viewing, modifying, overwriting, moving, deleting models, creating databases for models and so on, granted or revoked by the system admin per predetermined security policies.

3. An apparatus comprising:
A remote database wherein contains true random numbers generated by physical processes such as Quantum devices;
A remote database that stores user's previously parameterized models, model inputs and model simulation outputs;
A Model Evaluation module that assigns the modeling, parameterizing and updating tasks to the other modules and divides an entire problem to a set of sub-problems for instant and parallel computation;
A Temporary Storage server that stores the sub-models and corresponding variables;
A Cloud based Computing grid that finishes the computing tasks assigned;
A Synthesizing module that synthesizes the simulation results of sub-problems;
A benchmarking module that aggregates the input and/or simulation results of the users per approval, and benchmarks and displays a particular model/organization/industry in terms of the uncertainty and risk level per request;
A web based user interface which is either in tabular or click-and-point format, and can be ported to portable devices including but not limited to, smart phones, tablets, watches, calculators, Google glasses and etc.
